(19) United States
(12) Patent Application Publication
(10) Pub. No.: US 2020/0364645 A1
(43) Pub. Date: Nov. 19, 2020

(54) SAFETY LEADERSHIP ENHANCEMENT SYSTEM AND METHOD

(71) Applicant: Consolidated Edison Company of New York, Inc., New York, NY (US)

(72) Inventors: Eddy De La Hoz, Fishkill, NY (US); Scott Marotta, Danbury, CT (US); Nancy A. DePasquale, Bronx, NY (US); Richard Roesler, Staten Island, NY (US)

(21) Appl. No.: 16/867,098

(22) Filed: May 5, 2020

Related U.S. Application Data
(60) Provisional application No. 62/847,506, filed on May 14, 2019.

(51) Int. Cl. G06Q 10/06

(52) U.S. Cl. CPC G06Q 10/06398; G06F 17/18; G06Q 10/063114; G06Q 10/06393

(57) ABSTRACT

A computer-implemented method includes determining respective scores in a plurality of general categories related to safety leadership performance of a supervisory group. Input is received from a manager of the supervisory group in a manager category related to the safety leadership performance of the supervisory group. A supervisory scorecard is generated describing the safety leadership performance of the supervisory group, where the supervisory scorecard includes an overall score based on the respective scores in the plurality of general categories and the manager category. At least a portion of the supervisory scorecard is integrated into a section scorecard describing the safety leadership performance of sections, where the supervisory group is part of those sections. A safety leadership performance (SLP) curve is generated, mapping respective section SLP rates of the sections to respective positions on the SLP curve, based in part on the supervisory scorecard.

### CROSS-REFERENCE TO RELATED APPLICATIONS

The present application claims the benefit of and is a nonprovisional application of U.S. Provisional Application Ser. No. 62/847,506 filed on May 14, 2019, the contents of which is incorporated by reference herein in its entirety.

### BACKGROUND

The present invention relates to safety performance and, more specifically, to dynamically enhancing safety leadership and performance.

Various organizations must be concerned about the safety of their workers and contractors. Such organizations include those with plants, warehouses, factories, or field operations. Currently, safety performance is measured in terms of selected key lagging performance indicators. For instance, the proprietary DuPont Bradley curve is a system that enables organizations to benchmark their safety performance based on OSHA Incidence Rates.

### SUMMARY

Embodiments of the present invention are directed to a computer-implemented method for remediating safety leadership performance. A non-limiting example of the computer-implemented method includes determining a respective score in each category of a plurality of general categories related to safety leadership performance of a first supervisory group in an organization. Input is received from at least one manager of the first supervisory group in at least one manager category related to the safety leadership performance of the first supervisory group. A first supervisory scorecard is generated describing the safety leadership performance of the first supervisory group, where the first supervisory scorecard has an overall score based at least in part on the respective scores in the plurality of general categories and at least one manager category. At least a portion of the first supervisory scorecard is integrated into a section scorecard describing the safety leadership performance of two or more sections of the organization, where the first supervisory group is part of the two or more sections. A safety leadership performance (SLP) curve is generated, mapping respective section SLP rates of the two or more sections of the organization to respective positions on the SLP curve, based at least in part on the first supervisory scorecard for the first supervisory group.

Embodiments of the present invention are directed to a system for remediating safety leadership performance. A non-limiting example of the system includes a memory having computer-readable instructions and one or more processors for executing the computer-readable instructions. The computer-readable instructions cause the one or more processors to determine a respective score in each category of a plurality of general categories related to safety leadership performance of a first supervisory group in an organization. The computer-readable instructions further cause the one or more processors to receive input from at least one manager of the first supervisory group in at least one manager category related to the safety leadership performance of the first supervisory group. The computer-readable instructions further cause the one or more processors to generate a first supervisory scorecard describing the safety leadership performance of the first supervisory group. The first supervisory scorecard has an overall score based at least in part on the respective scores in the plurality of general categories and the at least one manager category. The computer-readable instructions further cause the one or more processors to integrate at least a portion of the first supervisory scorecard into a section scorecard describing the safety leadership performance of two or more sections of the organization, where the first supervisory group is part of the two or more sections. Additionally, the computer-readable instructions further cause the one or more processors to generate an SLP curve mapping respective section SLP rates of the two or more sections of the organization to respective positions on the SLP curve, based at least in part on the first supervisory scorecard for the first supervisory group.

Embodiments of the invention are directed to a computer-program product for remediating safety leadership performance, the computer-program product including a computer-readable storage medium having program instructions embodied therewith. The program instructions are executable by a processor to cause the processor to perform a method. A non-limiting example of the method includes determining a respective score in each category of a plurality of general categories related to safety leadership performance of a first supervisory group in an organization. Further according to the method, input is received from at least one manager of the first supervisory group in at least one manager category related to the safety leadership performance of the first supervisory group. A first supervisory scorecard is generated describing the safety leadership performance of the first supervisory group, where the first supervisory scorecard has an overall score based at least in part on the respective scores in the plurality of general categories and the at least one manager category. At least a portion of the first supervisory scorecard is integrated into a section scorecard describing the safety leadership performance of two or more sections of the organization, where the first supervisory group is part of the two or more sections. An SLP curve is generated, mapping respective section SLP rates of the two or more sections of the organization to respective positions on the SLP curve, based at least in part on the first supervisory scorecard for the first supervisory group. The safety leadership performance of a first section of the two or more sections is automatically remediated responsive to the section SLP rate of the first section failing to meet a threshold.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE SEVERAL VIEWS OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of a safety-enhancement (SE) system 100, according to some embodiments of this disclosure;

FIGS. 2A-2B illustrate an example supervisory safety leadership performance (SLP) scorecard, according to some embodiments;

FIG. 3 illustrates an example section-level SLP scorecard, according to some embodiments;

FIG. 4 illustrates the limited Dupont Bradley Curve;

FIG. 5 is a diagram of an example SLP curve, according to some embodiments;

FIG. 6 is a flow diagram of a method of determining and remediating section SLP rates to enhance safety leadership, according to some embodiments; and

FIG. 7 is a block diagram of a computer system for implementing some or all aspects of the SE system, according to some embodiments.

The diagrams depicted herein are illustrative. There can be many variations to the diagram or the operations described therein without departing from the spirit of the invention. For instance, the actions may be performed in a differing order or actions may be added, deleted or modified.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections or positional relationships, unless otherwise specified, can be direct or indirect, and the present invention is not intended to be limited in this respect. Moreover, the various tasks and process operations described herein can be incorporated into a more comprehensive procedure or process having additional steps or functionality not described in detail herein, or one or more tasks or operations may be optional without departing from the scope of the invention.

The following definitions and abbreviations are to be used for the interpretation of the claims and the specification. As used herein, the terms “comprises,” “comprising,” “includes,” “including,” “has,” “having,” “contains,” or “containing,” or another variation thereof, are intended to cover a non-exclusive inclusion. For example, a composition, mixture, process, method, article, or apparatus that comprises a list of elements is not necessarily limited to only those elements but can include other elements not expressly listed or inherent to such composition, mixture, process, method, article, or apparatus.

Additionally, the terms “at least one” and “one or more” may be understood to include a number greater than or equal to one (e.g., one, two, three, four, etc.). The term “a plurality” may be understood to include a number greater than or equal to two (e.g., two, three, four, five, etc.). The terms “about,” “substantially,” or “approximately,” or variations thereof, are intended to include a degree of error associated with measurement of the particular quantity based upon the equipment available.

For the sake of brevity, conventional techniques related to making and using aspects of the invention may or may not be described in detail herein. In particular, various aspects of computing systems to implement the various technical features described herein may be well known. Accordingly, in the interest of brevity, some conventional implementation details are only mentioned briefly herein or are omitted entirely without providing the well-known system or process details.

Turning now to an overview of technologies that are more specifically relevant to aspects of the invention, current safety performance measuring techniques are not fully integrated into the business process and do not encourage leadership in safety performance. For instance, current use of the Dupont Bradley Curve focuses on the relative safety culture for the organization as a function of the OSHA rate and it does not measure safety performance at the supervisor and worker level, therefore it does not provide specific information to encourage managers and supervisors to be safety leaders.

One or more embodiments of the invention address the above-described shortcomings of the prior art by improving safety performance and leadership through the use of management tools, such as key safety performance indicators that are both leading and lagging, objective and subjective at the supervisor and worker level. Embodiments of the invention teach, apply, and measure safety leadership practices across an organization, from management down to individual performances. Embodiments of the invention can be utilized in various business fields to enhance safety culture by promoting safety leadership at all levels.

Some embodiments are based on the Dupont Bradley Curve but consider a wider range of factors, in addition to teaching and encouraging leadership as well as individual responsibility. For instance, the following are a set of principals that can be incorporated into some embodiments of this disclosure, over and above the Dupont Bradley Curve: (1) Safety excellence is only achievable in an interdependent culture where employees are aligned and help each other conform through internal motivation and commitment to safety. (2) Managers and supervisors must be strong safety leaders in order to achieve an interdependent culture. Leadership qualities provide encouragement needed for safety excellence. (3) Safe practices must be integrated into the business process. This includes communication and feedback, as well as tools that will allow for tracking, measuring, and trending safety performance.

Embodiments of this invention identify individuals and business sections that demonstrate safety leadership through defined data points and performance indicators. This standardization allows for complete transparency for coaching, recognition, or rewarding safety leaders. Additionally or alternatively, some embodiments generate group performance trends and comparisons across one or more organizations.

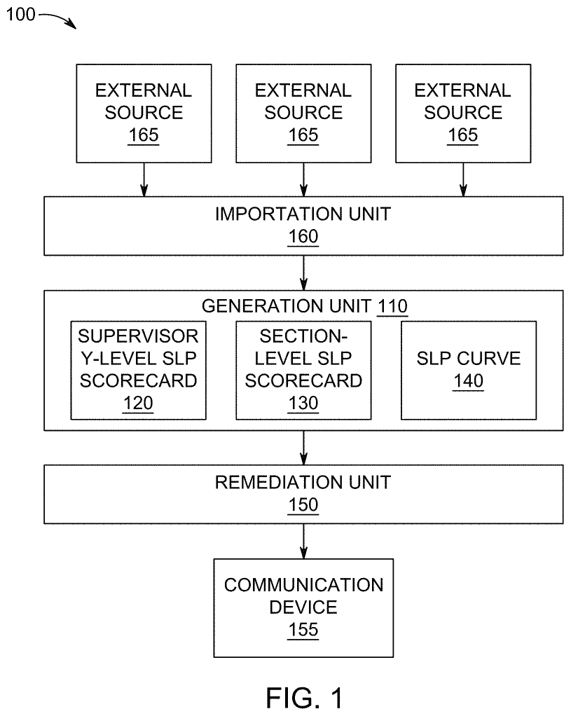

FIG. 1 is a block diagram of a safety-enhancement (SE) system 100, according to some embodiments of this disclosure. As shown in FIG. 1, the SE system 100 may include a generation unit 110 for generating a supervisory-level safety leadership performance (SLP) scorecard 120, a section-level SLP scorecard 130, and an organizational SLP curve 140; a remediation unit 150; and an importation unit 160. Each of these components may be embodied in one or more computing devices. For example, each of the supervisory-level SLP scorecard 120, the section-level SLP scorecard 130, and the SLP curve 140 may be generated by generation unit 110, which may be hardware or software, or a combination of both, and the remediation unit 150 and the importation unit 160 may each be hardware or software, or a combination of both. For instance, the generation unit, the remediation unit 150, and the importation unit 160 may each be a module in a software application or a specialized hardware device. The remediation unit 150 may have access to at least one communication device 155, such as WiFi, another network connection, a display screen, or a printer; and the importation unit 160 may interface with one or more external sources 165 to receive data useable by the SE system 100. Although the generation unit 110, the remediation unit 150, and the importation unit 160 are shown in FIG. 1 as being distinct components, this is for illustrative purposes only, and these components may be integrated together or further divided. Each of these elements of the SE system 100 will be described in more detail below.

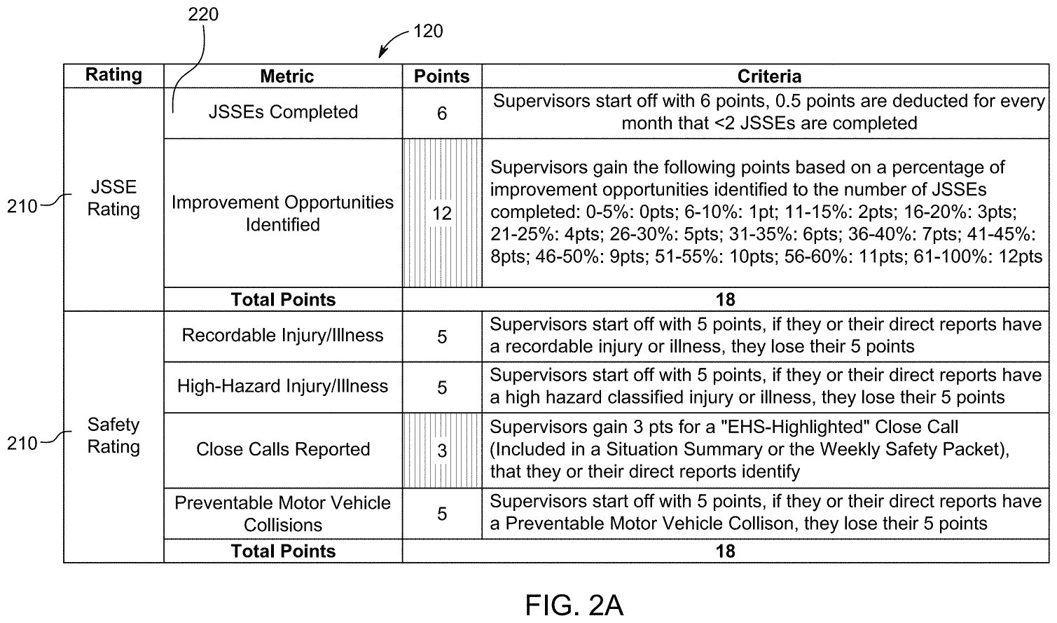

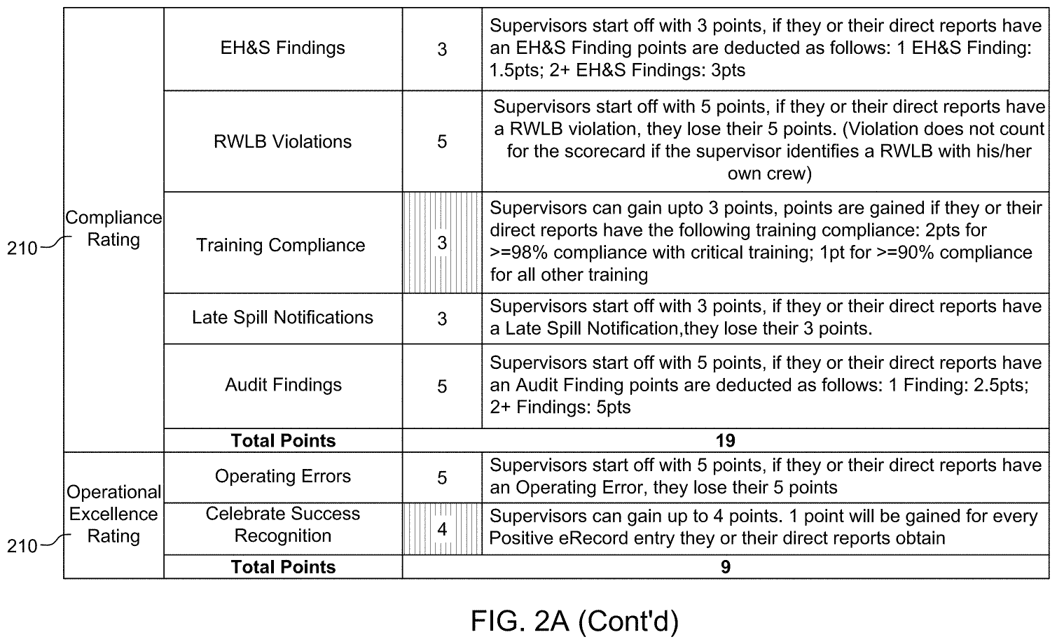

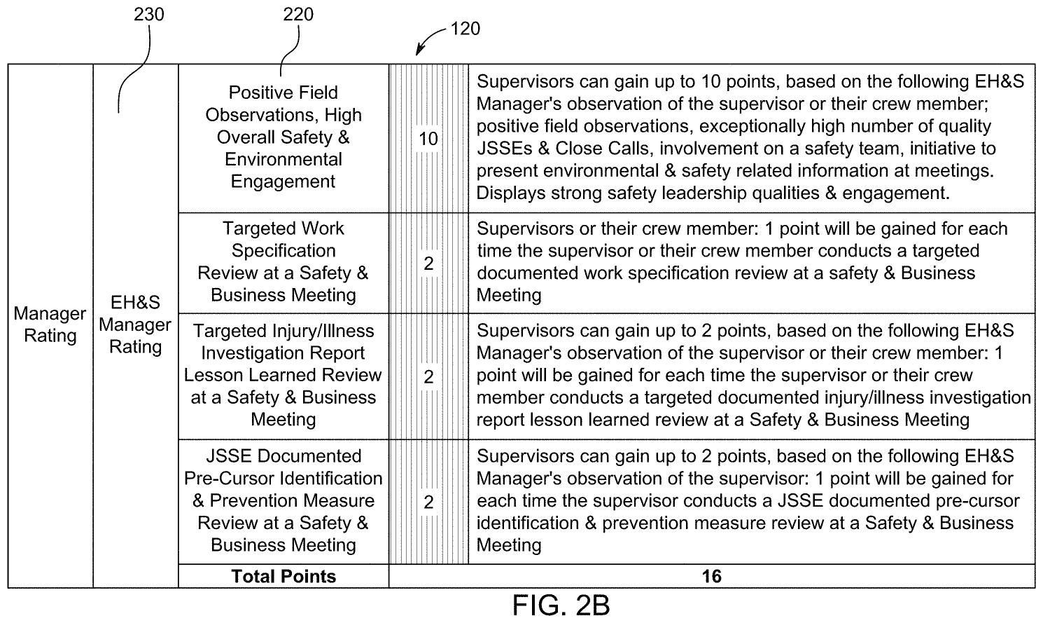

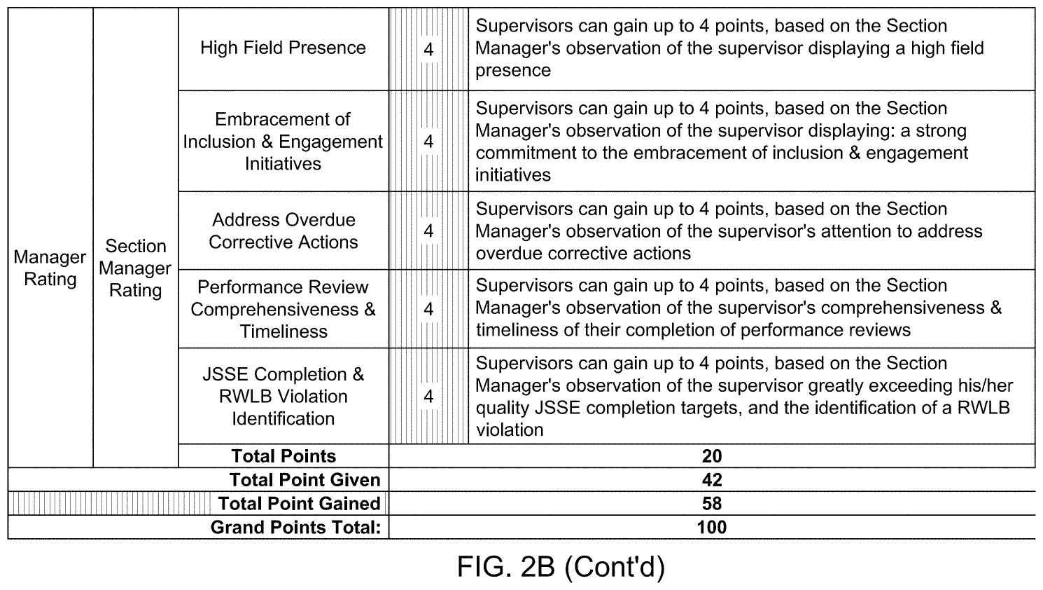

FIGS. 2A-2B illustrate an example supervisory-level SLP scorecard 120, according to some embodiments. Generally, the supervisory-level SLP scorecard 120 may be used to evaluate an individual who is a supervisor, such that the individual has one or more direct reports (i.e., other individuals who report to the supervisor), or to evaluate a group made up of an individual in addition to his or her direct reports. The supervisory-level SLP scorecard 120 may include two or more categories 210, such that the individual may receive a respective score, or rating, for each category. The supervisory-level SLP scorecard 120 as a whole may be assigned a score, or rating, that is a combination (e.g., the sum or a weighted mean) of the respective scores in the various categories 210. In other words, the overall score of the supervisory-level SLP scorecard 120 may be determined recursively by combining the scores of the various categories, which are themselves evaluated as combinations of their respective sub-categories 220, if any.

In some embodiments, the supervisory-level SLP scorecard 120 is evaluated over an evaluation term. More specifically, the supervisory-level SLP scorecard 120 may be evaluated on a rolling basis according to the evaluation term. For example, and not by way of limitation, the supervisory-level SLP scorecard 120 may be evaluated on a twelve-month rolling basis, such that the previous twelve months at a given time determine the values (i.e., scores) in the supervisory-level SLP scorecard 120, including the overall score of the supervisory-level SLP scorecard 120.

Some of the various factors (e.g., categories 210 and sub-categories 220) described herein as making up mere parts of the supervisory-level SLP scorecard 120 are based on one or a combination of established guidelines, such as organizational guidelines or Occupational Safety and Health Administration (OSHA) guidelines, and as such, one of skill in the art will understand how to evaluate these factors in light of such guidelines.

Specifically, for instance, the supervisory-level SLP scorecard 120 may include one or more of the following categories 210, as shown in FIG. 2A: Job Site Safety Exchange (JSSE) Rating, Safety Rating, Compliance Rating, and Operational Excellence Rating, along with one or more manager categories 230. Job Site Safety Exchanges refer to documented exchanges led by operating supervisors of crews in the field. In this example, the manager categories 230 are Environment, Health, and Safety (EH&S) Manager and Section Manager. However, various other manager categories 230 and other categories 210 may be used in place of or in combination with these. Each of the categories 210 may have one or more sub-categories 220, each of which may be assigned a score. Each category score may be a combination of the scores of its respective sub-categories 220, and the total score of the supervisory-level SLP scorecard 120 in turn may be a combination of the various category scores.

In some embodiments, each score at the lowest level of scoring (e.g., sub-categories 220) within a category 210 may be classified as either a default or earned score type. Generally, a default score is given by default, such that the score may be reduced under certain circumstances, while an earned score begins at zero and is increased under certain circumstances. Thus, before scoring begins for an individual, the individual may already have a default score, which is based on a combination of the scores in the supervisory-level SLP scorecard 120 that are default scores. As the supervisory-level SLP scorecard 120 is evaluated, however, the values of the default scores may decrease and the value of the earned scores may increase.

Following, the various sub-categories 220 in the example of FIGS. 2A-2B are described in detail. It will be understood that these details are exemplary only, as are the categories 210. According to some embodiments, the supervisory-level SLP scorecard 120 may include various categories 210 and sub-categories 220 that include none, some, or all of those described herein.

In this example, the JSSE Rating category 210 includes the following sub-categories 220: JSSEs Completed and Improvement Opportunities Identified. JSSEs Completed has a default score, in which 6 points are assigned by default. A portion of the points, specifically half a point in this example, are deducted for every month that fewer than an allotted number of JSSEs, specifically two JSSEs in this example, are not completed by the individual. The sub-category 220 of improvement opportunities identified may be an earned score type, in which the individual being scored gains points based on a percentage of improvement opportunities identified while performing JSSEs during the evaluation term. For example, and not by way of limitation, the following ranges of percentage may map to the following scores in this category: 0-5% improvement opportunities identified maps to 0; 6-10% maps to 1; 11-15% maps to 2; 16-20% maps to 3; 21-25% maps to 4; 26-30% maps to 5; 31-35% maps to 6; 36-40% maps to 7; 41-45% maps to 8; 46-50% maps to 9; 51-55% maps to 10; 56-60% maps to 11; and 61-100% maps to 12. More generally, for instance, the score in this sub-category 220 may increase according to percentage ranges until a threshold percentage (e.g., 61% in this example) is reached, at which point the maximum point value is awarded as the score.

In this example, the category 210 of Safety Rating includes the following sub-categories 220: Recordable Injuries and Illnesses, High-Hazard Injuries and Illnesses, Close Calls Reported, and Preventable Motor Vehicle Collisions (MVCs). As used herein “Recordable Injuries and Illnesses” means work related injuries and illnesses that meet the OSHA definition for recordability. As used herein “High-Hazard Injuries and Illnesses” means injuries that arise from electrical, gas or steam systems, including but not limited to, electrical shocks, burns, exposure to asphyxiants, equipment/material impacts, or falls from heights greater than 4-feet, and require hospitalization for medical treatment exclusive of observation/diagnostic procedures. As used herein “Close Calls Reported” means situations or conditions reported by company employees that may lead to a potential injury, illness, environmental incident, motor vehicle collision, property damage, or that need to be corrected. As used herein “Preventable Motor Vehicle Collisions” (MVCs) means contact between employee-operated company vehicles and other vehicles, pedestrians, cyclists, or stationary objects, resulting in damage and/or injury; and excludes events in which the company vehicle was struck: 1) in the rear bumper while stopped or proceeding in a traffic lane (note: merging and turning-related events are recordable); 2) while stationary in a traffic lane (e.g., stopped at a traffic signal); and 3) while parked.

It should be appreciated that these categories expand on the OSHA recordable events. The OSHA standard governing recordable incidents is standard 29 CFR Part 1904. Individual states or territories that have separate OSHA-approved occupational health and safety requirements may have additional recordkeeping and reporting requirements beyond those described in the OSHA standard. The OSHA's recording standards mandate that severe injuries and illnesses must be reported directly to the OSHA in addition to being recorded by the employer. For instance, all work-related deaths must be reported to the OSHA within an eight-hour period, and all in-patient hospitalizations and amputations must be reported within a 24-hour period. These reports must be made directly either by telephone or by using a dedicated online form. All other recordable injuries or illnesses must be recorded on applicable OSHA 300 forms and held for five years. Injuries and illnesses that are considered recordable include instances that require surgery, prescription medication, casts, or stitches. Untreatable conditions such as certain fractures, measurable hearing loss, and chronic disability are also recordable. Injuries and illnesses that only require first aid are not considered to be OSHA recordable injuries. First aid includes treatments such as tetanus vaccinations (but not other vaccinations), the application of bandages, elastic support wraps, and massage (but not physical therapy).

The sub-category 220 of Recordable Injuries and Illnesses has a default score of 5, and all points are lost if the individual or his or her direct reports have any recordable injuries or illnesses in the evaluation term. The sub-category 220 of High-Hazard Injury and Illnesses has a default score of 5 in this example, where all points are lost if the individual or direct reports have an injury or illness classified as a high hazard. The sub-category 220 of Close Calls Reported has an earned score of up to 3, where the individual gains all three points for any EHS-highlighted close call (i.e., deemed a close call according to Environment, Heath, and Safety concerns) that the individual or direct reports identify. The sub-category 220 of Preventable Motor Vehicle Collisions has a default score of 5, where the individual loses all five points if the individual or direct reports have a motor vehicle collision deemed preventable.

In this example, the category 210 of Compliance Rating includes the following sub-categories 220: EH&S Findings, Rules We Live By (RWLB) Violations, Training Compliance, Late Spill Notifications, and Audit Findings. The sub-category 220 of EH&S Findings has a default score of 3, where points are deducted for EH&S findings. For instance, for a single EH&S finding, 1.5 points are lost, and for two or more EH&S findings, all points are lost. The sub-category 220 of RWLB Violations has a default score of 5, where all points are lost if the individual or any direct reports have an RWLB in the evaluation term. In some embodiments, however, the violation does not count if the individual identifies the violation within his or her own crew (i.e., the individual and his or her direct reports). The sub-category 220 of Training Compliance has an earned score of up to 3, where points are gained according to the training compliance of the individual's direct reports. For instance, the individual may gain 2 points for greater than or equal to 98% compliance for critical training, or a single point for less than 98% compliance for critical training but at least 90% compliance for all training. The sub-category 220 of Late Spill Notification has a default score of 3, where all points are lost if the individual or direct reports have a late spill notification. The sub-category 220 of Audit Findings has a default score of 5, where points are deducted based on whether any audit findings exist for the individual or direct reports. For instance, for a single finding, half the points are lost, and for 2 or more findings, all 5 points are lost.

In this example, as shown, the category 210 of Operational Excellence Rating has the following sub-categories 220: Operating Errors and Celebrate Success Recognition. The sub-category 220 of Operating Errors has a default score of 5, where all points are lost if the individual or direct reports are responsible for an operating error. The sub-category 220 of Celebrate Success Recognition has a maximum earned score of 4, where a point is earned for each positive electronic record of a success for the individual or direct reports.

As discussed above, the supervisory-level SLP scorecard 120 may include various manager categories 230, which are shown under the highlight of “Manager Rating” in FIG. 2B. Each such manager category 230 may be a category 210 under which a manager of the individual can manually assign further points to the individual. Thus, through manager categories 230, a manager can rate an individual's safety performance subjectively or objectively, or both. Typically, in some embodiments, the manager categories 230 have earned points rather than default points, but this need not be the case. Each manager category 230 in the supervisory-level SLP scorecard 120 may be associated with a manager in the organization, where that manager is other than the individual. In some embodiments, the various manager categories 230 are associated with managers having varying relationships to the individual, such that a broad picture of the individual's safety record is reflected through the various manager categories 230. For instance, in the example of FIG. 2B, the manager categories 230 are EH&S Manager and Section Manager. In this example, the Section Manager category 230 is associated with a section manager who is a direct manager of the individual associated with the supervisory-level SLP scorecard 120, while the EH&S Manager category 230 is associated with a non-direct manager who potentially has a different perspective of the individual. Further, in some embodiments, the sub-categories 220 for each manager category 230 are selected to cover subjects that the associated manager is in a position to observe. Each manager associated with a manager category 230 of an individual's supervisory-level SLP scorecard 120 may be required or expected to evaluate the individual for the supervisory-level SLP scorecard 120 on a periodic basis, such as quarterly.

In this example, the EH&S Manager category 230 includes the following sub-categories 220, each of which has an earned score assigned to the individual by the EH&S manager: Positive Field Observations, High Overall Safety & Environment Engagement; Targeted Work Specification Review at a Safety & Business Meeting; Targeted Injury and Illness Investigation Report Lesson Learned View at a Safety & Business Meeting; and JSSE Documents Precursor Identification & Prevention Measure Review at a Safety & Business Meeting. For the sub-category 220 of Positive Field Observations, High Overall Safety & Environment Engagement, the EH&S manager can assign up to 16 points based on observations of the individual and his or her direct reports, including positive field observations, exceptionally high number of quality JSSEs and close calls, involvement on safety teams, initiative to present environmental and safety related information at meetings, and whether the individual generally displays strong safety leadership qualities and engagement. For the sub-category 220 of Targeted Work Specification Review at a Safety & Business Meeting, the manager can assign up to 2 points, with a point for each time the individual or direct reports conduct a targeted documented work specification review at a Safety & Business Meeting or other designated safety-related meeting. For the sub-category 220 of Targeted Injury and Illness Investigation Report Lesson Learned View at a Safety & Business Meeting, the manager can assign up to 2 points based on the manager's observation of the individual and direct reports. For instance, a point may be gained for each time the individual or direct reports conduct a targeted documented injury or illness investigation report lesion learned review at a Safety & Business Meeting or other designated safety-related meeting. For the sub-category 220 of JSSE Documents Precursor Identification & Prevention Measure Review at a Safety & Business Meeting, the manager can assign up to 2 points, based on the manager's observation of the individual and direct reports, where a point is gained each time the individual or direct reports conducts a JSSE documented precursor identification and prevention measure review at a Safety & Business Meeting or other designated safety-related meeting.

In this example, the Section Manager category 230 includes the following sub-categories 220, the Section Manager can assign up to 20 points based on observations of the individual and his or her direct reports, each of which has an earned score assigned to the individual by the section manager: High Field Presence; Embracement of Inclusion & Engagement Initiatives; Address Overdue Corrective Actions; Performance Review Comprehensiveness & Timeliness; Performance Review Comprehensiveness & Timeliness; and JSSE Completion & RWLB Violation Identification. For the sub-category 220 of High Field Presence, the manager can assign up to four points based on the manager's observation of the individual's field presence. For the sub-category 220 of Embracement of Inclusion & Engagement Initiatives, the manager can assign up to four points based on the manager's observation of the individual's display of strong commitment to the embracement of inclusion and engagement activities. For the sub-category 220 of Address Overdue Corrective Actions, the manager can assign up to four points based on observation of the individual's attention to addressing overdue corrective actions. For the sub-category 220 of Performance Review Comprehensiveness & Timeliness, the manager can assign up to four points based on observation of the individual's comprehensiveness and timeliness of their completion of performance reviews for their direct reports or others. For the sub-category 220 of JSSE Completion & RWLB Violation Identification, the manager can assign up to four points based on observation of whether the individual greatly exceeds his or her quality JSSE completion targets and observation of the individual's identification of any RWLB violations.

It will be understood that the various scores in the various categories 210 may combine to a fixed maximum value and that the overall score, or final value, of a supervisory-level SLP scorecard 120 may be a combination (e.g., the sum) of the scores in the various categories 210. Thus, each category 210 may be evaluated, and the value of the supervisory-level SLP scorecard 120 as a whole may be evaluated based on evaluations of the categories 210. In this example, the maximum score for all categories 210 except the manager categories 230 is 64, and the maximum for the manager categories 230 is 36, leading to 100 possible points total. As shown in FIGS. 2A-2B, sub-categories 220 with default scores add to 42, while the maximum sum of the earned scores is 58, leading to the same total of 100 points maximum available for the supervisory-level SLP scorecard 120 in this example.

The importation unit 160 of the SE system 100 may receive data from external sources 165, such as a user portal, a portal to a repository, or through the use of an application programming interface (API) to an external source. In some embodiments, for instance, the importation unit 160 may interface with legacy systems to provide information in these legacy systems to the SE system 100 for evaluating safety leadership and performance. The received data may be utilized by the generation unit 110 in evaluating the supervisory-level SLP scorecard 120 or the section-level SLP scorecard 130, as described below.

While some of the above values in the supervisory-level SLP scorecard 120 may be manually entered (e.g., points for sub-categories 220 in the manager categories 230), and thereby received at the importation unit 160 through a manual interface, others may be imported automatically through one or more interfaces with external sources 165. For example, and not by way of limitation, the importation unit 160 of the SE system 100 may communicate with Employee Data Warehouse (EDW) for import of employee information; JSSEs and JSSE Improvements for information about JSSEs; Obvient, Logica, and Customer Relationship Management System (CRMS) for specific appointments and inquiries, which may be useful, for instance, to determine safety for particular events at the job level; and various interfaces of Supply House Information Management System (SHIMS), such as SHIMS Illness, SHIMS Injury, SHIMS High Hazard, SHIMS Motor Vehicle, SHIMS Close Calls, and SHIMS Red Lights. In some embodiments, the importation unit 160 may additionally or alternatively receive data from audit findings, training compliance, and electronic records, as well as manual entry of manager ratings. Additionally or alternatively, the importation unit 160 may interface with one or more repositories, such as through portals to those repositories, such as: an operating errors repository; an RWLB violations repository; and a late spill notification repository. In some embodiments, one or more of SHIMS Red Lights, JSSE Improvements, Audit Findings, Operating Errors, or other elements may provide case-related data to the SE system 100. In other words, these elements may provide data that is delineated by each instance, such that instances (e.g., each close call) can be isolated an examined individually. It will be understood, however, that data from other elements may also, or alternatively, by case-related. In some embodiments, some or all of these elements may have APIs useable by the importation unit 160 to import information as needed to evaluate individuals according to the supervisory-level SLP scorecard 120 or otherwise.

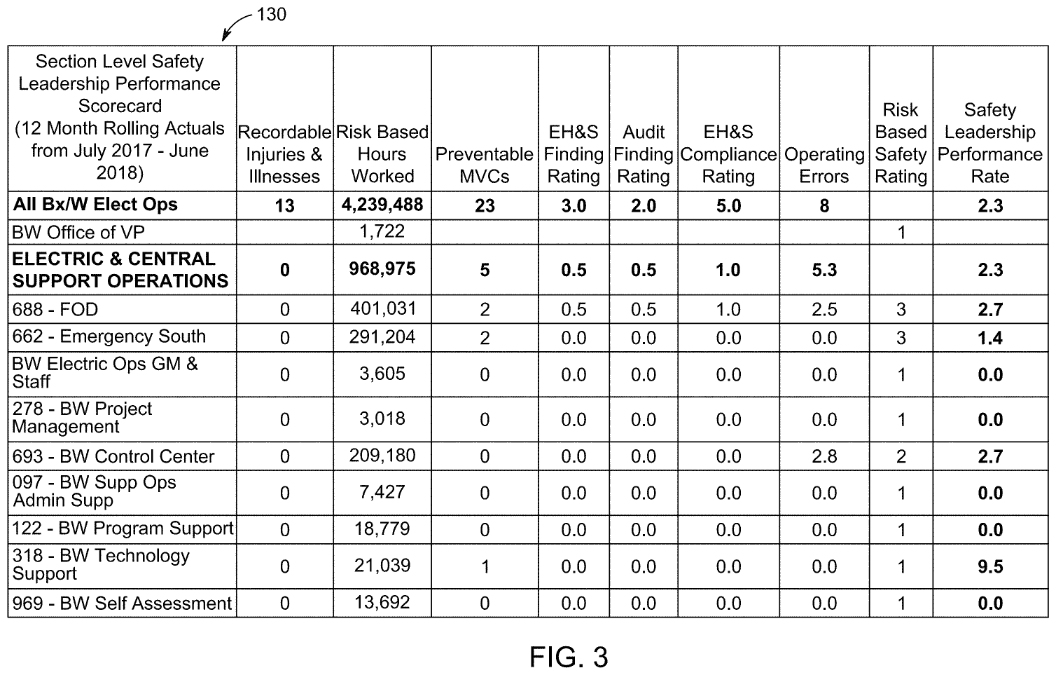

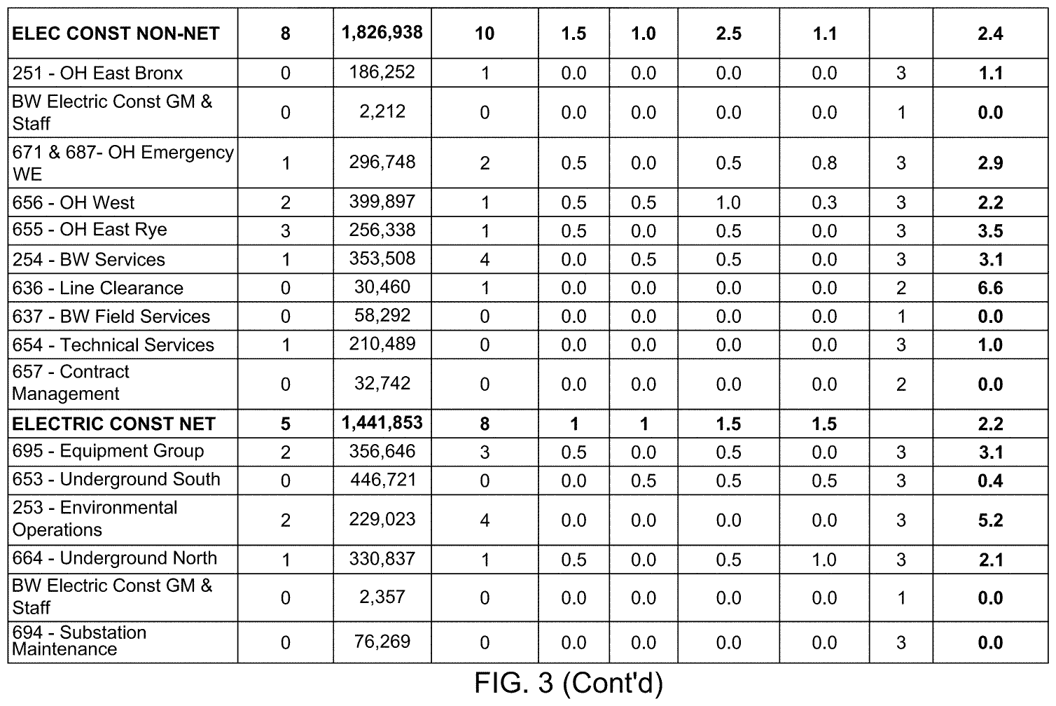

FIG. 3 illustrates an example section-level SLP scorecard 130 according to some embodiments of the invention. According to some embodiments, the section-level SLP scorecard 130 scores one or more sections, each of which is made up one or more entities (e.g., individuals or groups) scored by a supervisory-level SLP scorecard 120. In other words, the section-level SLP scorecard 130 can be viewed as an aggregation of a set of supervisory-level SLP scorecards 200.

As shown in FIG. 3, in some embodiments, the section-level SLP scorecard 130 includes a set of categories 210, some or all of which may be selected from the supervisory-level SLP scorecard 120 or imported from external sources 165. In this example, the categories 210 are shown as columns. The last column is the SLP rate, also referred to as a safety score, the calculation of which will be described in more detail below. The first column is a record identifier column, indicating which group or individual is represented by each respective row. In this example, three sections are represented in three highlighted rows, other than the top row: Electrical & Central Support Operations, Elec Const Non-Net, and Electric Const Net. The rows beneath each highlighted row represent groups making up the section row highlighted above. For instance, in this example, the section of Electric & Central Support Operations includes the following groups that are deemed part of that section: FOD, Emergency South, BW Electric Ops GM & Staff, BW Project Management, BW Control Center, BW Supp Ops Admin Supp, BW Program Support, BW Technology Support, and BW Self-Assessment.

A subset of the columns may be associated with categories 210 of the supervisory-level SLP scorecard 120. Each such column of a row representing an entity shows a value that is based on the value associated with the associated category 210 in the supervisory-level SLP scorecard 120 for that entity. For instance, the values in columns for Recordable Injuries & Illnesses, Preventable Motor Vehicle Collisions (MVCs), EH&S Finding Rating, Audit Finding Rating, and Operating Errors are taken from the supervisory-level SLP scorecard 120 evaluated for each entity. For each such column, the value in the supervisory-level SLP scorecard 120 for the entity may be placed in the column, or the value placed in the column may be otherwise based on the value in the applicable category 210 of the supervisory-level SLP scorecard 120 for the entity.

Other than those based on the supervisory-level SLP scorecard 120, in this example, the remaining columns are for Section Level Safety Leadership Performance Scorecard; Risk-Based Hours Worked; Risk-Based Safety Rating; and Safety Leadership Performance Rate. As discussed above, the first of these is an identifier column, which identifies the entity associated with each row. The Risk-Based Hours Worked column indicates how many risk-based hours were worked for the entity in the evaluation term. Additionally or alternatively, however, total hours worked or some other measurement of time spent in conditions for which safety is being encouraged could be used. In some embodiments, the values in this column are imported from one or more external sources 165. The Safety Leadership Performance Rate column gives the final safety leadership performance rate (SLPR) of each entity.

In some embodiments, the SLPR, which appears the last column of the example section-level SLP scorecard 130 above, is calculated as follows for entities:

(RI&I+PMVC+Findings+OE+RWLB)×200,000 RAHW

In this formula, RI&I is the number of recordable injuries and illnesses for the entity, PMVC is the number of preventable motor vehicle collisions, OE is the number of operating errors, and RWLB is the number of Rules We Live By violations. In some embodiments, Findings is a combination of EH&S findings and audit findings. For instance, the value of Findings may be a value in the range of [0, 1] inclusive. This value may be set to 0 by default, where 0.5 is added if the entity has at least one EH&S finding in the evaluation term, and 0.5 is added if the entity has at least one audit finding in the evaluation term. The number 200,000 is used, in some embodiments, because 200,000 represents the number of hours worked by 100 employees working 40 hours per week for 50 weeks per year, which is the OSHA baseline. The denominator, RAHW, is the risk-adjusted hours worked or another hours basis, which may be imported from an external source 165. Thus, in some embodiments, a lower SLPR is preferable as items in the nominator of this formula have negative connotations.

As mentioned above, the section rows in the section-level SLP scorecard 130 appear highlighted in this example. In some embodiments, as in this example, each such section row is an aggregation of the entities belonging to that section, which appear in rows following the section row in this example. More specifically, for each column other than the identifier column and the final column with the SLPR, the section row includes a sum of the rows representing entities within that section. However, in some embodiments, as in this example, the SLPR for each section is a weighted average. More specifically, the SLPR of each entity in the section is weighted by the risk-based hours worked, such that the section SLPR (i.e., the SLPR of the section as a whole) is the sum of the weighted SLPRs, further divided by the total risk-based work hours for the section.

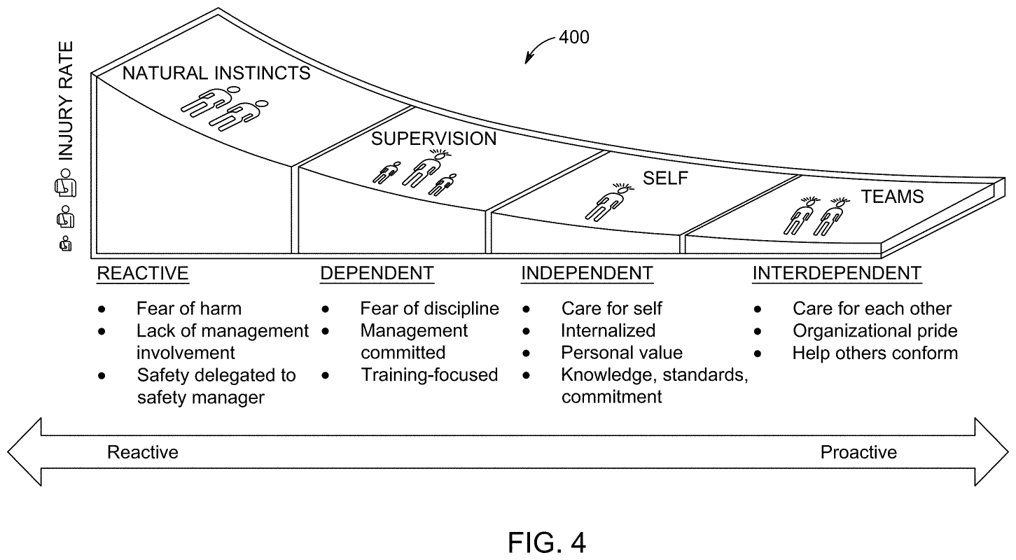

FIG. 4 illustrates the Dupont Bradley Curve 400, which is a basis for an SLP curve used according to some embodiments. As shown in FIG. 4, the Dupont Bradley Curve 400 maps and classifies individuals on the range from reactive to proactive. Individuals are deemed less reactive and more proactive as they transform from Reactive to Dependent to Independent to Interdependent. Reactive individuals are characterized by fear of harm, lack of management involvement, and having safety delegated to a safety manager. Dependent individuals are characterized by fear of discipline, being management committed, and being training-focused. Independent individuals are characterized by care for self, having internalized safety concerns, showing personal value, and having knowledge, standards, and commitment to safety. Interdependent individuals are characterized by care for one another, organizational pride, and helping others conform.

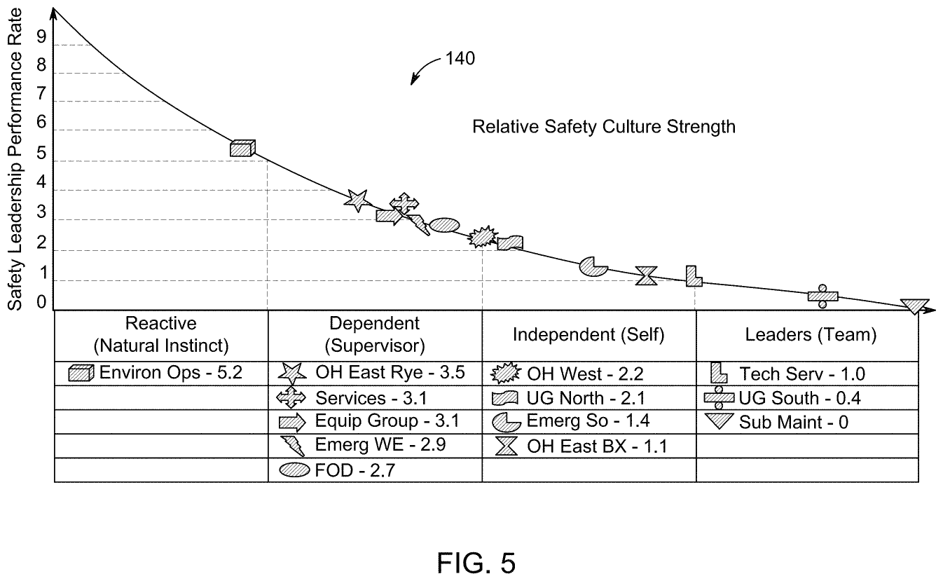

FIG. 5 is a diagram of an example SLP curve 140, according to some embodiments of the invention. As shown, the SLP curve has commonalities with the Dupont Bradley Curve 400 but incorporates additional factors according to some embodiments, specifically, the factors incorporated into the section-level SLP scorecard 130, which is based in part on the supervisory-level scorecard 300. In some embodiments, each section SLPR is plotted along the SLP curve 140. For instance, as shown in FIG. 5, the Environ Ops section has an SPLR of 5.2, and thus Environ Ops is associated with the vertex along the SLP curve where the value of the SLP curve 140 has the value of 5.2. Similarly, other sections have associated vertices plotted on the SLP curve 140.

As shown in FIG. 5, sections may be classified based on their section SLPRs and, more specifically, where their SLPRs fall on the SLP curve 140. As shown in this example, sections whose SLPRs fall in the first range are classified as Reactive; sections whose SLPRs fall in a second range lower than the first are classified as Dependent, or Supervisor; sections whose SLPRs fall in a third range lower than the second range are classified as Independent, or Self; and sections whose SLPRs fall into a fourth range lower than the third range are classified as Leaders, or Team.

Generally, an SLPR may be calculated for each section based on characteristics of entities within that section, which may be determined according to the supervisory-level SLP scorecard 120 for each such entity. The SLPR for each section may then be plotted on the SLP curve as shown in FIG. 5. In some embodiments, the process of determining SLPRs of sections or the final SLP curve 140 with plotted sections, or both, may be transparent to individuals in the organization. As a result, members of the organization can see where they fall on the SLP curve 140 may therefore seek to improve. A transparent process further enables individuals to see precisely how they can improve (e.g., by reducing preventable motor vehicle collisions). Further, the SLP curve 140 with plotted sections can create healthy competition among sections, encouraging section leaders to encourage those within their sections to make improvements in areas that impact the SLPRs.

In some embodiments, the remediation unit 150 provides automated remediation to assist sections in improving their section SLPRs. For example, and not by way of limitation, the remediation unit 150 may automatically notify (e.g., via email or text message) each section leader of the section SLPR or of the SLPRs of individuals or groups within the section, and the remediation unit 150 may automatically notify each individual within each section of the individual's SLPR. Further, the remediation unit 150 may notify to provide section leaders or others with actions steps for how they can improve their SLPRs. In some embodiments, such improvements are suggested for a section where the respective section SLPR is deemed low, such as by failing to meet a static or dynamic threshold for static SLPRs. For instance, a dynamic SLPR threshold may be based on SLPRs of other sections, such that a section is encouraged to keep up with the safety leadership of other sections. For further example, and not by way of limitation, for each factor (e.g., preventable MVCs, operation errors) of the SLPR that is above a respective threshold for that factor, the remediation unit 150 may suggest taking steps to lower that factor. In some embodiments, the SE system 100 may automatically schedule trainings or other tasks to enable individuals to improve their SLPRs or an applicable section SLPR.

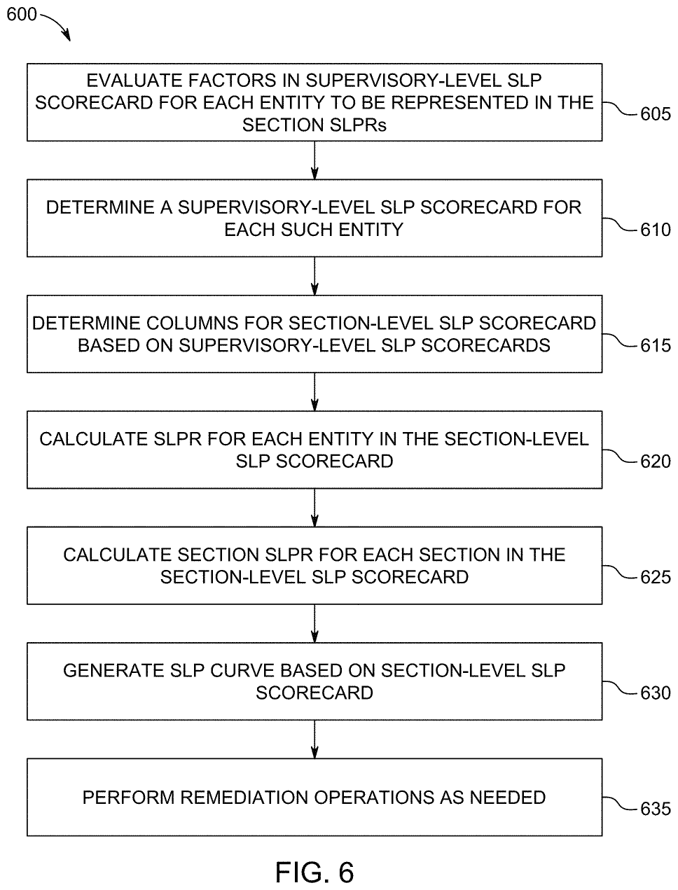

FIG. 6 is a flow diagram of a method 600 of determining and remediating section SLPRs to enhance safety leadership, according to some embodiments. As shown in FIG. 6, at block 605, the various factors in the supervisory-level SLP scorecard 120 are evaluated for each entity in each section for which an SLPR is being calculated. At block 610, a supervisory-level SLP scorecard 120 is determined for each such entity. At block 615, with the exception of the SLPR column, columns of a section-level SLP scorecard 130 are determined for the various sections of the organization. At block 620, the SLPR is calculated for each entity other than sections of the section-level SLP scorecard 130. At block 625, the section SLPRs are determined based on the SLPRs of the other entities in the section. At block 630, an SLP curve 140 is generated using the section SLPRs, and this SLP curve 140 may be provided to various entities represented, such as groups or individuals who are managers, supervisors, or section leaders. At block 635, the SE system 100 may perform remediation operations, such as scheduling training or notifying individuals of how they can decrease their SLPRs or their section SLPRs.

In some embodiments, this method 600 is performed periodically to update the SLPRs of each section of the organization. For example, and not by way of limitation, the method 600 or similar may be performed quarterly using the prior twelve months as an evaluation term, resulting in a rolling twelve-month rating system.

The SE system 100 described herein has various benefits over existing safety performance evaluation mechanisms. The SE system 100 may be a standardized safety system based on both objective and subjective evaluations. In some embodiments, the SE system 100 provides visibility into safety performance and culture, and the SE system 100 can do so across various regions and business types. For instance, the factors (e.g., sub-categories 220 and categories 210) considered may be modified as appropriate for a different organization. In some embodiments, the automated importation of data enables the identification of safety performance at the project level. Importation along with automated scoring can minimize or reduce potentially time-intensive research of EH&S incidents, and auto-generated notifications can highlight safety performance and trends as well as enhance and track action items. As a result, the SE system 100 may motivate employees to become safety leaders and may empower management to identify areas that require improvement.

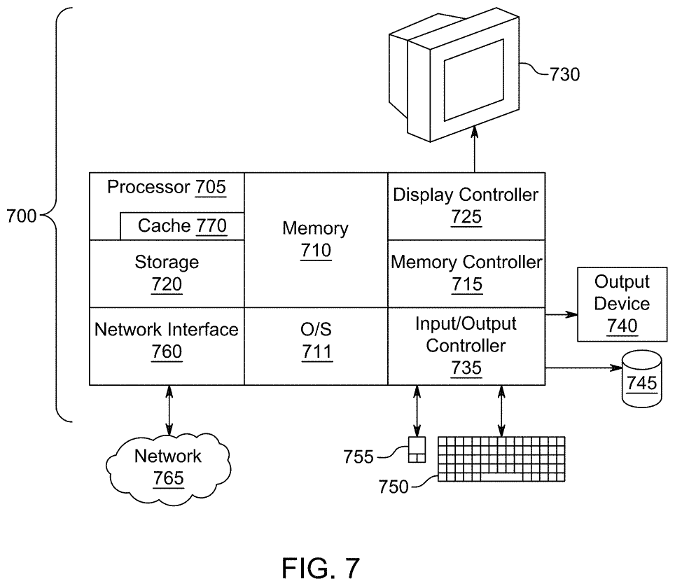

FIG. 7 is a block diagram of a computer system 700 for implementing some or all aspects of the SE system 100, according to some embodiments of this invention. The SE systems 100 and methods described herein may be implemented in hardware, software (e.g., firmware), or a combination thereof. In some embodiments, the methods described may be implemented, at least in part, in hardware and may be part of the microprocessor of a special or general-purpose computer system 700, such as a personal computer, workstation, minicomputer, or mainframe computer. For example, and not by way of limitation, each of the generation unit 110, the remediation unit 150, and the importation unit 160 may be implemented as one or more computer systems 700 or portions thereof.

In some embodiments, as shown in FIG. 7, the computer system 700 includes a processor 705, memory 710 coupled to a memory controller 715, and one or more input devices 745 and/or output devices 740, such as peripherals, that are communicatively coupled via a local I/O controller 735. These devices 740 and 745 may include, for example, a printer, a scanner, a microphone, and the like. Input devices such as a conventional keyboard 750 and mouse 755 may be coupled to the I/O controller 735. The I/O controller 735 may be, for example, one or more buses or other wired or wireless connections, as are known in the art. The I/O controller 735 may have additional elements, which are omitted for simplicity, such as controllers, buffers (caches), drivers, repeaters, and receivers, to enable communications.

The I/O devices 740, 745 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 705 is a hardware device for executing hardware instructions or software, particularly those stored in memory 710. The processor 705 may be a custom made or commercially available processor, a central processing unit (CPU), an auxiliary processor among several processors associated with the computer system 700, a semiconductor-based microprocessor (in the form of a microchip or chip set), a macroprocessor, or other device for executing instructions. The processor 705 includes a cache 770, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 770 may be organized as a hierarchy of more cache levels (L1, L2, etc.).

The memory 710 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 710 may incorporate electronic, magnetic, optical, or other types of storage media. Note that the memory 710 may have a distributed architecture, where various components are situated remote from one another but may be accessed by the processor 705.

The instructions in memory 710 may include one or more separate programs, each of which comprises an ordered listing of executable instructions for implementing logical functions. In the example of FIG. 7, the instructions in the memory 710 include a suitable operating system (OS) 711. The operating system 711 essentially may control the execution of other computer programs and provides scheduling, input-output control, file and data management, memory management, and communication control and related services.

Additional data, including, for example, instructions for the processor 705 or other retrievable information, may be stored in storage 720, which may be a storage device such as a hard disk drive or solid-state drive. The stored instructions in memory 710 or in storage 720 may include those enabling the processor to execute one or more aspects of the SE systems 100 and methods of this disclosure.

The computer system 700 may further include a display controller 725 coupled to a display 730. In some embodiments, the computer system 700 may further include a network interface 760 for coupling to a network 765. The network 765 may be an IP-based network for communication between the computer system 700 and an external server, client and the like via a broadband connection. The network 765 transmits and receives data between the computer system 700 and external systems. In some embodiments, the network 765 may be a managed IP network administered by a service provider. The network 765 may be implemented in a wireless fashion, e.g., using wireless protocols and technologies, such as WiFi, WiMax, etc. The network 765 may also be a packet-switched network such as a local area network, wide area network, metropolitan area network, the Internet, or other similar type of network environment. The network 765 may be a fixed wireless network, a wireless local area network (LAN), a wireless wide area network (WAN) a personal area network (PAN), a virtual private network (VPN), intranet or other suitable network system and may include equipment for receiving and transmitting signals.

Safety-enhancement systems 100 and methods according to this disclosure may be embodied, in whole or in part, in computer program products or in computer systems 700, such as that illustrated in FIG. 7.

The description of the present invention has been presented for the purpose of illustration. This description is not intended to be exhaustive or to limit the invention to the forms disclosed. Many modifications and variations will be apparent to those of ordinary skill in the art without departing from the scope and spirit of the invention. The embodiments of the invention discussed herein were chosen and described in order to best explain the principles of the invention and the practical applications, and to enable others of ordinary skill in the art to understand the invention. While certain embodiments of the invention have been described, it will be understood that those skilled in the art, both now and in the future, may make various improvements and enhancements that fall within the scope of the claims that follow.

What is claimed is:

1. A computer-implemented method comprising:
determining a respective score in each category of a plurality of general categories related to safety leadership performance of a first supervisory group in an organization;
receiving input from at least one manager of the first supervisory group in at least one manager category related to the safety leadership performance of the first supervisory group;
generating a first supervisory scorecard describing the safety leadership performance of the first supervisory group, wherein the first supervisory scorecard comprises an overall score based at least in part on the respective scores in the plurality of general categories and the at least one manager category;
integrating at least a portion of the first supervisory scorecard into a section scorecard describing the safety leadership performance of two or more sections of the organization, wherein the first supervisory group is part of the two or more sections; and
generating a safety leadership performance (SLP) curve mapping respective section SLP rates of the two or more sections of the organization to respective positions on the SLP curve, based at least in part on the first supervisory scorecard for the first supervisory group.

2. The computer-implemented method of claim 1, wherein the receiving input from the at least one manager of the first supervisory group in the at least one manager category related to the safety leadership performance of the first supervisory group comprises:
receiving a first input from a first manager in a first manager category related to the safety leadership performance of the first supervisory group, wherein the first manager is a direct manager of the first supervisory group;
receiving a second input from a second manager in a second manager category related to the safety leadership performance of the first supervisory group, wherein the second manager is an indirect manager of the first supervisory group; and
wherein the overall score of the first supervisory scorecard is based at least in part on the first input from the first manager and the second input from the second manager.

3. The computer-implemented method of claim 1, wherein the integrating the at least a portion of the first supervisory scorecard into the section scorecard describing the safety leadership performance of the two or more sections of the organization comprises:
aggregating data from a plurality of supervisory scorecards, representing a plurality of supervisory groups of the organization, into section data describing safety leadership performance of a first section of the two or more sections; and
calculating the respective SLP rate of each supervisory scorecard of the plurality of supervisory scorecards, wherein the SLP rate is based on a combination of factors in the plurality of supervisory scorecards and is inversely proportional to risk-based hours worked by the plurality of supervisory groups represented by the plurality of supervisory scorecards.

4. The computer-implemented method of claim 3, wherein the generating the safety leadership performance (SLP) curve mapping respective section SLP rates of the two or more sections of the organization to respective positions on the SLP curve comprises calculating the respective section SLP rate of each section of the two or more sections as a weighted average of the respective SLP rates of the respective supervisory groups within each section.

5. The computer-implemented method of claim 4, further comprising categorizing each section of the two or more sections based on where each section falls on the SLP curve.

6. The computer-implemented method of claim 3, further comprising automatically remediating the safety leadership performance of the first section responsive to the section SLP rate of the first section failing to meet a threshold.

7. The computer-implemented method of claim 3, further comprising interfacing with one or more external sources to import data used in evaluating the plurality of supervisory scorecards.

8. The computer-implemented method of claim 1, further comprising notifying each of the two or more sections of the respective positions of the two or more sections on the SLP curve.

9. A system comprising:
a memory having computer-readable instructions; and
one or more processors for executing the computer-readable instructions to: determine a respective score in each category of a plurality of general categories related to safety leadership performance of a first supervisory group in an organization;
receive input from at least one manager of the first supervisory group in at least one manager category related to the safety leadership performance of the first supervisory group;
generate a first supervisory scorecard describing the safety leadership performance of the first supervisory group, wherein the first supervisory scorecard
comprises an overall score based at least in part on the respective scores in the plurality of general categories and the at least one manager category;
integrate at least a portion of the first supervisory scorecard into a section scorecard describing the safety leadership performance of two or more sections of the organization, wherein the first supervisory group is part of the two or more sections; and
generate a safety leadership performance (SLP) curve mapping respective section SLP rates of the two or more sections of the organization to respective positions on the SLP curve, based at least in part on the first supervisory scorecard for the first supervisory group.

10. The system of claim 9, wherein receiving input from the at least one manager of the first supervisory group in the at least one manager category related to the safety leadership performance of the first supervisory group comprises:
receiving a first input from a first manager in a first manager category related to the safety leadership performance of the first supervisory group, wherein the first manager is a direct manager of the first supervisory group;
receiving a second input from a second manager in a second manager category related to the safety leadership performance of the first supervisory group, wherein the second manager is an indirect manager of the first supervisory group; and
wherein the overall score of the first supervisory scorecard is based at least in part on the first input from the first manager and the second input from the second manager.

11. The system of claim 9, wherein integrating the at least a portion of the first supervisory scorecard into the section scorecard describing the safety leadership performance of the two or more sections of the organization comprises:
aggregating data from a plurality of supervisory scorecards, representing a plurality of supervisory groups of the organization, into section data describing safety leadership performance of a first section of the two or more sections; and
calculating the respective SLP rate of each supervisory scorecard of the plurality of supervisory scorecards, wherein the SLP rate is based on a combination of factors in the plurality of supervisory scorecards and is inversely proportional to risk-based hours worked by the plurality of supervisory groups represented by the plurality of supervisory scorecards.

12. The system of claim 11, wherein generating the safety leadership performance (SLP) curve mapping respective section SLP rates of the two or more sections of the organization to respective positions on the SLP curve comprises calculating the respective section SLP rate of each section of the two or more sections as a weighted average of the respective SLP rates of the respective supervisory groups within each section.

13. The system of claim 12, wherein the one or more processors are further configured to execute the computer-readable instructions to categorize each section of the two or more sections based on where each section falls on the SLP curve.

14. The system of claim 11, wherein the one or more processors are further configured to execute the computer-readable instructions to automatically remediate the safety leadership performance of the first section responsive to the section SLP rate of the first section failing to meet a threshold.

15. A computer-program product for remediating safety leadership performance, the computer-program product comprising a computer-readable storage medium having program instructions embodied therewith, the program instructions executable by a processor to cause the processor to perform a method comprising:
determining a respective score in each category of a plurality of general categories related to safety leadership performance of a first supervisory group in an organization;
receiving input from at least one manager of the first supervisory group in at least one manager category related to the safety leadership performance of the first supervisory group;
generating a first supervisory scorecard describing the safety leadership performance of the first supervisory group, wherein the first supervisory scorecard comprises an overall score based at least in part on the respective scores in the plurality of general categories and the at least one manager category;
integrating at least a portion of the first supervisory scorecard into a section scorecard describing the safety leadership performance of two or more sections of the organization, wherein the first supervisory group is part of the two or more sections;
generating a safety leadership performance (SLP) curve mapping respective section SLP rates of the two or more sections of the organization to respective positions on the SLP curve, based at least in part on the first supervisory scorecard for the first supervisory group; and
automatically remediating the safety leadership performance of a first section of the two or more sections responsive to the section SLP rate of the first section failing to meet a threshold.

16. The computer-program product of claim 15, wherein the receiving input from the at least one manager of the first supervisory group in the at least one manager category related to the safety leadership performance of the first supervisory group comprises:
receiving a first input from a first manager in a first manager category related to the safety leadership performance of the first supervisory group, wherein the first manager is a direct manager of the first supervisory group;
receiving a second input from a second manager in a second manager category related to the safety leadership performance of the first supervisory group, wherein the second manager is an indirect manager of the first supervisory group; and
wherein the overall score of the first supervisory scorecard is based at least in part on the first input from the first manager and the second input from the second manager.

17. The computer-program product of claim 15, wherein the integrating the at least a portion of the first supervisory scorecard into the section scorecard describing the safety leadership performance of the two or more sections of the organization comprises:
aggregating data from a plurality of supervisory scorecards, representing a plurality of supervisory groups of the organization, into section data describing safety leadership performance of a first section of the two or more sections; and
calculating the respective SLP rate of each supervisory scorecard of the plurality of supervisory scorecards, wherein the SLP rate is based on a combination of factors in the plurality of supervisory scorecards and is inversely proportional to risk-based hours worked by the plurality of supervisory groups represented by the plurality of supervisory scorecards.

18. The computer-program product of claim 17, wherein the generating the safety leadership performance (SLP) curve mapping respective section SLP rates of the two or more sections of the organization to respective positions on the SLP curve comprises calculating the respective section SLP rate of each section of the two or more sections as a weighted average of the respective SLP rates of the respective supervisory groups within each section.

19. The computer-program product of claim 18, the method further comprising categorizing each section of the two or more sections based on where each section falls on the SLP curve.

20. The computer-program product of claim 15, the method further comprising notifying each of the two or more sections of the respective positions of the two or more sections on the SLP curve.
